(19) United States
(12) Patent Application Publication
(10) Pub. No.: US 2019/0366795 A1
(43) Pub. Date: Dec. 5, 2019

(54) COOLING ASSEMBLY AND A PASSENGER COMPARTMENT FOR A VEHICLE THAT UTILIZES THE COOLING ASSEMBLY

(71) Applicant: GM Global Technology Operations LLC, Detroit, MI (US)

(72) Inventors: Kuo-Huey Chen, Troy, MI (US); Taeyoung Han, Bloomfield Hills, MI (US); Bahram Khalighi, Birmingham, MI (US)

(73) Assignee: GM Global Technology Operations LLC, Detroit, MI (US)

(21) Appl. No.: 16/000,124

(22) Filed: Jun. 5, 2018

(51) Int. Cl. B60H 1/00

(52) U.S. Cl. CPC B60H 1/0055; B60H 1/00478

(57) ABSTRACT

A cooling assembly includes an instrument panel. A passenger compartment for a vehicle can also utilize the cooling assembly. The instrument panel includes a first surface and a second surface opposing the first surface. The cooling assembly also includes a thermoelectric apparatus coupled to one of the first and second surfaces. The thermoelectric apparatus includes a first conductive plate and a second conductive plate spaced apart from each other. The first and second conductive plates are configured to be at different temperatures from each other during operation of the thermoelectric apparatus. The cooling assembly further includes a film secured to one of the first and second surfaces of the instrument panel and thermally connected to one of the first and second conductive plates of the thermoelectric apparatus such that operation of the thermoelectric apparatus causes the film to decrease in temperature by an amount sufficient for cooling the instrument panel.

### INTRODUCTION

Many vehicles include a passenger compartment which can be accessible by one or more doors. The vehicles can include a windshield and the doors can include windows. During a hot sunny day, solar energy can enter the passenger compartment through the windshield and windows, which can cause the passenger compartment to heat up. Therefore, on a hot sunny day, the passenger compartment can be hot when a passenger enters the passenger compartment.

### SUMMARY

The present disclosure provides a cooling assembly including an instrument panel. The instrument panel includes a first surface and a second surface opposing the first surface. The cooling assembly also includes a thermoelectric apparatus coupled to one of the first and second surfaces. The thermoelectric apparatus includes a first conductive plate and a second conductive plate spaced apart from each other. The first and second conductive plates are configured to be at different temperatures from each other during operation of the thermoelectric apparatus. The cooling assembly further includes a film secured to one of the first and second surfaces of the instrument panel and thermally connected to one of the first and second conductive plates of the thermoelectric apparatus such that operation of the thermoelectric apparatus causes the film to decrease in temperature by an amount sufficient for cooling the instrument panel.

The cooling assembly optionally includes one or more of the following:

A) the first conductive plate is configured to decrease in temperature during operation of the thermoelectric apparatus and the second conductive plate is configured to increase in temperature during operation of the thermoelectric apparatus;

B) the film is secured to the second surface of the instrument panel and the film is thermally connected to the first conductive plate;

C) the film decreases in temperature as the first conductive plate decreases in temperature due to the thermal connection between the film and the first conductive plate;

D) a fastening feature attached to the film and the first conductive plate to thermally connect the film and the first conductive plate;

E) the fastening feature is an adhesive formed of a thermally conductive material;

F) a heat exchanger coupled to one of the first and second conductive plates;

G) the heat exchanger is coupled to the second conductive plate to remove heat from the thermoelectric apparatus;

H) the heat exchanger includes a fan configured to move heated air away from the thermoelectric apparatus;

I) the heat exchanger includes a plurality of fins secured to the second conductive plate and configured to absorb heat from the second conductive plate;

J) the heat exchanger includes a fan disposed adjacent to the fins and configured to move air over the fins and expel the air heated via the fins away from the thermoelectric apparatus;

K) the heat exchanger defines at least one fluid chamber configured to contain a liquid that absorbs heat from the fins and moves the liquid heated via the fins away from the thermoelectric apparatus;

L) the film is formed of graphene;

M) the graphene has a thermal conductivity of about 3000 to about 5000 Watts/meter-Kelvin at room temperature;

N) the film is formed of a thermal conductive material of about 3000 to about 5000 Watts/meter-Kelvin at room temperature;

O) the film is formed of a thermal conductive material of about 1200 to about 2000 Watts/meter-Kelvin at room temperature;

P) the thermoelectric apparatus is coupled to the second surface of the instrument panel;

Q) the film is secured to the second surface of the instrument panel and at least partially abuts the second surface of the instrument panel;

R) the film is thermally connected to the first conductive plate;

S) the film decreases in temperature due to the thermal connection with the first conductive plate;

T) an adhesive formed of a thermally conductive material, and the adhesive thermally connects the film and the first conductive plate;

U) a heat exchanger coupled to the second conductive plate to remove heat from the second conductive plate; and

V) the heat exchanger includes a heat removal apparatus configured to move heat from the fins away from the thermoelectric apparatus.

The present disclosure also provides a passenger compartment for a vehicle. The passenger compartment includes an instrument panel, and the instrument panel includes an instrument cluster having a face. The instrument panel includes a first surface and a second surface opposing the first surface. At least a portion of the first surface of the instrument panel and the face of the instrument cluster are configured to be visible inside the passenger compartment. The passenger compartment also includes a cooling assembly coupled to the instrument panel. The cooling assembly includes a thermoelectric apparatus coupled to one of the first and second surfaces. The thermoelectric apparatus includes a first conductive plate and a second conductive plate spaced apart from each other. The first and second conductive plates are configured to be at different temperatures from each other during operation of the thermoelectric apparatus. The cooling assembly further includes a film secured to one of the first and second surfaces of the instrument panel and thermally connected to one of the first and second conductive plates of the thermoelectric apparatus such that operation of the thermoelectric apparatus causes the film to decrease in temperature by an amount sufficient for cooling the instrument panel.

The passenger compartment optionally includes one or more of the following:

A) the thermoelectric apparatus is coupled to the second surface of the instrument panel;

B) the first conductive plate is configured to decrease in temperature during operation of the thermoelectric apparatus and the second conductive plate is configured to increase in temperature during operation of the thermoelectric apparatus;

C) the film is secured to the second surface of the instrument panel and at least partially abuts the second surface of the instrument panel;

D) the film is thermally connected to the first conductive plate;

E) the film decreases in temperature due to the thermal connection with the first conductive plate;

F) the cooling assembly includes an adhesive formed of a thermally conductive material, and the adhesive thermally connects the film and the first conductive plate;

G) the cooling assembly includes a heat exchanger coupled to the second conductive plate to remove heat from the second conductive plate;

H) the heat exchanger includes a plurality of fins secured to the second conductive plate and configured to absorb heat from the second conductive plate;

I) the heat exchanger includes a heat removal apparatus configured to move heat from the fins away from the thermoelectric apparatus;

J) the thermoelectric apparatus is a first thermoelectric apparatus and the film is a first film, and wherein the first thermoelectric apparatus is coupled to the second surface of the instrument panel, and wherein the first film is secured to the second surface of the instrument panel and the first film is thermally connected to the first conductive plate of the first thermoelectric apparatus;

K) the cooling assembly includes a second thermoelectric apparatus that includes a first conductive plate and a second conductive plate spaced apart from each other, and wherein the first film is thermally connected to the first conductive plate of the second thermoelectric apparatus;

L) the cooling assembly includes a second film secured to the second surface of the instrument panel and the second film is thermally connected to the first conductive plate of the second thermoelectric apparatus;

M) the first conductive plate of the first thermoelectric apparatus and the first conductive plate of the second thermoelectric apparatus are both configured to decrease in temperature during operation of the respective first and second thermoelectric apparatuses;

N) the second conductive plate of the first thermoelectric apparatus and the second conductive plate of the second thermoelectric apparatus are both configured to increase in temperature during operation of the respective first and second thermoelectric apparatuses; and

O) the first film decreases in temperature as at least the first conductive plate of the first thermoelectric apparatus decreases in temperature due to the thermal connection between the first film and the first conductive plate of the first thermoelectric apparatus.

The detailed description and the drawings or FIGS. are supportive and descriptive of the disclosure, but the claim scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic perspective view of a vehicle.

FIG. 2 is a schematic illustration of an instrument panel and a steering wheel from inside a passenger compartment of the vehicle.

FIG. 3 is a schematic fragmentary view of the instrument panel and a cooling assembly.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims.

Referring to the FIGS., wherein like numerals indicate like or corresponding parts throughout the several views, a vehicle 10 and part of a cooling assembly 12 are generally shown in FIG. 1.

For example, during a hot sunny day, the sun can warm the inside of the vehicle 10. As another example, if it is warm outside 14 of the vehicle 10, the external temperature can warm the inside of the vehicle 10. The cooling assembly 12 discussed below can assist in cooling the inside of the vehicle 10.

Therefore, as one non-limiting example, the cooling assembly 12 can be utilized in the vehicle 10. Non-limiting examples of the vehicle 10 can include vans, cars, sports cars, sport utility vehicles, trucks, recreational vehicles, boats, farm equipment or any other suitable movable platform. Additionally, the vehicle 10 can include autonomously driven vehicles or vehicles driven via a human. Furthermore, the vehicle 10 can be an electric vehicle, a hybrid vehicle, a traditional gas powered vehicle, etc. Non-limiting examples of the non-vehicles can include machines, farm equipment or any other suitable non-vehicle.

For the vehicle application as shown in FIG. 1, the vehicle 10 can include a body 16 defining a passenger compartment 18. Generally, the passenger compartment 18 is accessible by one or more doors 20. Therefore, when a passenger desires to enter or exit the passenger compartment 18, the passenger opens or closes the door 20 to allow ingress or egress. As such, the door(s) 20 are movable between an open position and a closed position relative to the passenger compartment 18. FIG. 1 illustrates the doors 20 in the closed position.

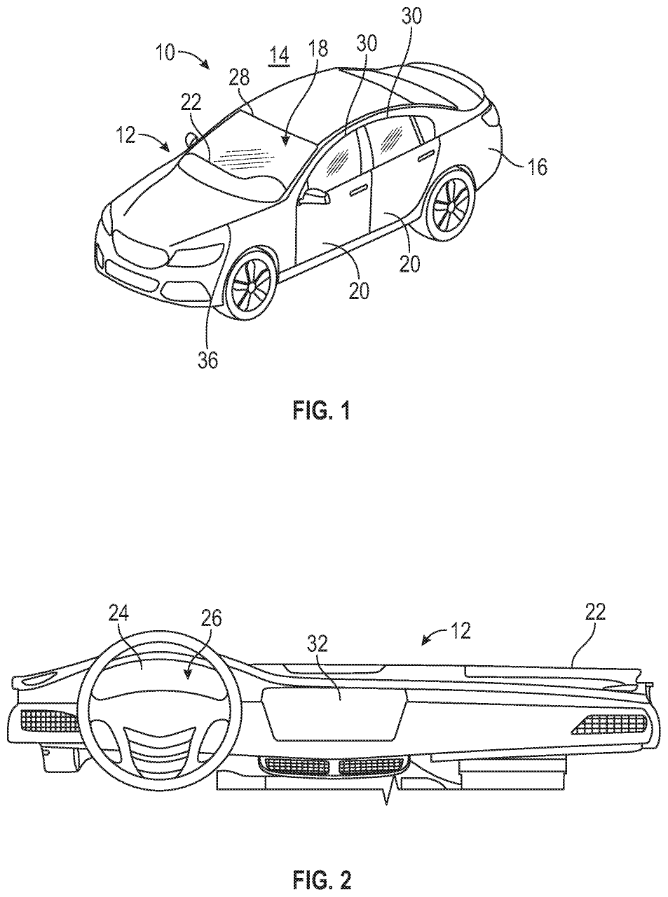

Referring to FIGS. 1 and 2, the vehicle 10 can include an instrument panel 22 disposed inside the passenger compartment 18. The cooling assembly 12 can be coupled to the instrument panel 22. In certain embodiments, it is to be appreciated that the cooling assembly 12 can include the instrument panel 22.

Referring to FIG. 2, the instrument panel 22 can include an instrument cluster 24 having a face 26. The instrument cluster 24 can convey various information to the passenger of the vehicle 10, such as the speed the vehicle 10 is traveling, the amount of fuel or battery life, etc. Furthermore, the instrument panel 22 can include one or more vents, one or more compartments, one or more airbags, etc.

Referring back to FIG. 1, the vehicle 10 can include a windshield 28, and one or more of the doors 20 can include a window 30. When the vehicle 10 is shut off, the sun can cause heat to build up inside the passenger compartment 18. For example, solar energy can cause the inside of the passenger compartment 18 to increase in temperature. The solar energy can radiate through the windshield 28 and/or the windows 30 to increase the temperature inside the passenger compartment 18. Furthermore, even on a cloudy day, if the temperature outside 14 of the vehicle 10 is greater than inside the vehicle 10, the passenger compartment 18 can increase in temperature.

For example, part of the instrument panel 22 can be directly exposed to the sun through the windshield 28, and thus, that part of the instrument panel 22 can become hot. It can be desirable to decrease the temperature of the passenger compartment 18 quickly once the vehicle 10 is started. Therefore, the cooling assembly 12 described herein assists in decreasing the temperature of the passenger compartment 18. The cooling assembly 12 can cool the instrument panel 22, and cooling the instrument panel 22 can decreases the temperature of the passenger compartment 18.

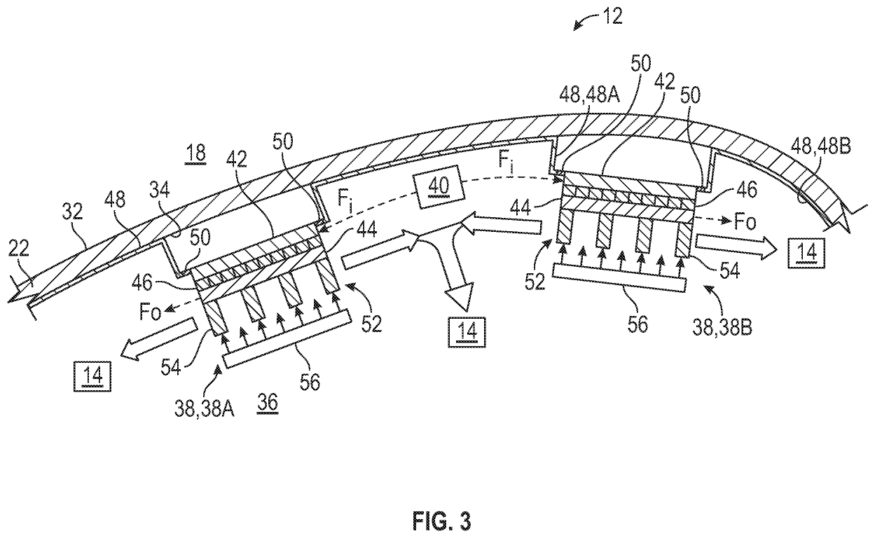

Referring to FIG. 3, the instrument panel 22 includes a first surface 32 and a second surface 34 opposing the first surface 32. In other words, the first and second surfaces 32, 34 of the instrument panel 22 are disposed or positioned opposite of each other. In certain embodiments, at least a portion of the first surface 32 of the instrument panel 22 and the face 26 of the instrument cluster 24 can be configured to be visible inside the passenger compartment 18. The second surface 34 can be hidden behind the first surface 32, which is not visible from inside the passenger compartment 18. The second surface 34 can generally face 26 an engine compartment or a storage compartment 36. Generally, the cooling assembly 12 described herein can cool the first and/or second surfaces 32, 34 of the instrument panel 22.

Continuing with FIG. 3, the cooling assembly 12 includes a thermoelectric apparatus 38. The thermoelectric apparatus 38 is utilized to cool the instrument panel 22, and more specifically cool the first and/or second surfaces 32, 34 of the instrument panel 22. Generally, the thermoelectric apparatus 38 can transfer thermal energy. Specifically, the thermoelectric apparatus 38 can utilize an electrical current 40 that causes heat to move from one side to another side, and thus, one side gets cooler while another side gets hotter. For example, the electrical current 40 can be a direct current (DC) that flows through the thermoelectric apparatus 38 to cause this temperature change between sides.

The thermoelectric apparatus 38 is coupled to one of the first and second surfaces 32, 34. In certain embodiments, the thermoelectric apparatus 38 can be coupled to the second surface 34 of the instrument panel 22. Generally, the thermoelectric apparatus 38 is coupled to one of the surfaces 32, 34 to position the thermoelectric apparatus 38 relative to the instrument panel 22. The thermoelectric apparatus 38 can be coupled to the instrument panel 22 by any suitable methods, and non-limiting examples can include adhesive, one or more fasteners, welding, molding, bonding, etc. Generally, the thermoelectric apparatus 38 is not visible from inside the passenger compartment 18.

Continuing with FIG. 3, the thermoelectric apparatus 38 includes a first conductive plate 42 and a second conductive plate 44 spaced apart from each other. The first and second conductive plates 42, 44 are configured to be at different temperatures from each other during operation of the thermoelectric apparatus 38. More specifically, the first conductive plate 42 can be configured to decrease in temperature during operation of the thermoelectric apparatus 38 and the second conductive plate 44 can be configured to increase in temperature during operation of the thermoelectric apparatus 38. As such, during operation of the thermoelectric apparatus 38, the electrical current 40 flows in (Fᵢ) through one of the first and second conductive plates 42, 44, and current flows out (Fₒ) through the other one of the first and second conductive plates 42, 44 which causes thermal energy to be transferred to create the temperature difference between the plates 42, 44.

The thermoelectric apparatus 38 can further include one or more semiconductors 46 between the first and second conductive plates 42, 44. Therefore, the first and second conductive plates 42, 44 are separated via the semiconductors 46. When the electrical current 40 is applied, the electrical current 40 flows through one of the plates 42, 44 to the other one of the plates 42, 44 through the semiconductors 46. As such, when the electrical current 40 is applied, heat from one of the plates 42, 44 moves to the other one of the plates 42, 44 through the semiconductors 46, which causes one of the plates 42, 44 to decrease in temperature and the other one of the plates 42, 44 to increase in temperature.

The thermoelectric apparatus 38 can include one or more materials composed of a skutterudite material, TAGs, PbTe, BiTe or other materials that have properties such that when the electrical current 40 is introduced, heat can be transferred from one of the conductive plates 42, 44 to the other one of the conductive plates 42, 44. The thermoelectric apparatus 38 can operate through a Peltier effect which uses the plates 42, 44 and the semiconductors 46 to create a temperature difference between the two plates 42, 44.

Continuing with FIG. 3, the cooling assembly 12 further includes a film 48 secured to one of the first and second surfaces 32, 34 of the instrument panel 22. Furthermore, the film 48 is thermally connected to one of the first and second conductive plates 42, 44 of the thermoelectric apparatus 38 such that operation of the thermoelectric apparatus 38 causes the film 48 to decrease in temperature by an amount sufficient for cooling the instrument panel 22. Therefore, during operation of the thermoelectric apparatus 38, the film 48 decreases in temperature which causes the instrument panel 22 to decrease in temperature, thus, cooling the passenger compartment 18.

In certain embodiments, the film 48 can be secured to the second surface 34 of the instrument panel 22. In various embodiments, the film 48 can at least partially abut the second surface 34 of the instrument panel 22. The film 48 can be secured to one of the surfaces 32, 34 of the instrument panel 22 by any suitable methods, and non-limiting examples can include adhesive, one or more fasteners, welding, molding, bonding, etc. Additionally, the film 48 can be any suitable thickness, length, width to provide the desired cooling of the instrument panel 22.

Furthermore, in certain embodiments, the film 48 can be thermally connected to the first conductive plate 42. As such, the film 48 can decrease in temperature due to the thermal connection with the first conductive plate 42. More specifically, the film 48 can decrease in temperature as the first conductive plate 42 decreases in temperature due to the thermal connection between the film 48 and the first conductive plate 42.

The film 48 can be formed of various thermal conductive material(s), and non-limiting examples are discussed below. As one example, the film 48 can be formed of a thermal conductive material of about 3000 to about 5000 Watts/meter-Kelvin at room temperature. As another example, the film 48 can be formed of a thermal conductive material of about 1200 to about 2000 Watts/meter-Kelvin at room temperature. As yet another example, the film 48 can be formed of a thermal conductive material of about 230 Watts/meter-Kelvin at room temperature.

In certain embodiments, the thermal conductive material can include carbon. Furthermore, in certain embodiments, the film 48 can be formed of graphene. For example, the graphene can have a thermal conductivity of about 3000 to about 5000 Watts/meter-Kelvin at room temperature. Graphene can include carbon.

In certain embodiments, the cooling assembly 12 can include a fastening feature 50 (see FIG. 3, the fastening feature 50 has been exaggerated in the figure for illustrative purposes only) attached to the film 48 and the first conductive plate 42 to thermally connect the film 48 and the first conductive plate 42. The fastening feature 50 can be configured to conduct thermal energy. As a non-limiting example, the fastening feature 50 can be an adhesive formed of a thermally conductive material. As such, the adhesive can be configured to conduct thermal energy. The adhesive can thermally connect the film 48 and the first conductive plate 42. During operation of the thermoelectric apparatus 38, the fastening feature 50 allows heat transfer between the film 48 and the respective plate 42, 44, such as the first conductive plate 42. It is to be appreciated that the fastening feature 50 can be any suitable configuration, material, etc. to thermally connect the film 48 and the respective plate 42, 44, such as the first conductive plate 42.

Continuing with FIG. 3, the cooling assembly 12 can further include a heat exchanger 52 coupled to one of the first and second conductive plates 42, 44. Generally, the heat exchanger 52 can be configured to remove heat from the thermoelectric apparatus 38. In certain embodiments, the heat exchanger 52 can be coupled to the second conductive plate 44 to remove heat from the thermoelectric apparatus 38. More specifically, in certain embodiments, the heat exchanger 52 can be coupled to the second conductive plate 44 to remove heat from the second conductive plate 44.

As discussed above, the second conductive plate 44 can increase in temperature during operation of the thermoelectric apparatus 38, and therefore, it can be desirable to remove the heat transferred to the second conductive plate 44. In various embodiments, the heat exchanger 52 can include a plurality of fins 54 (see FIG. 3) secured to the second conductive plate 44 and configured to absorb heat from the second conductive plate 44. Said differently, heat from the second conductive plate 44 can be transferred to the fins 54 of the heat exchanger 52. The fins 54 can be secured to the respective plate 42, 44, such as the second conductive plate 44, by any suitable methods, and non-limiting examples can include adhesive, one or more fasteners, welding, molding, bonding, etc.

Continuing with FIG. 3, the heat exchanger 52 can include a heat removal apparatus 56 configured to move heat from the fins 54 away from the thermoelectric apparatus 38. The heat removal apparatus 56 can be various configurations to remove heat from the thermoelectric apparatus 38. Specifically, the heat removal apparatus 56 can be configured to remove heat from the second conductive plate 44. The heat removal apparatus 56 can guide the heat toward the outside 14 of the vehicle 10.

In certain embodiments, the heat removal apparatus 56 can utilize air and/or liquid to remove the heat from the thermoelectric apparatus 38. As such, in certain embodiments, the heat exchanger 52 can include a fan configured to move heated air away from the thermoelectric apparatus 38. If utilizing the fan, the fan can be disposed adjacent to the fins 54 and configured to move air over the fins 54 and expel the air heated via the fins 54 away from the thermoelectric apparatus 38. Furthermore, in certain embodiments, the heat exchanger 52 can define at least one fluid chamber configured to contain a liquid that absorbs heat from the fins 54 and moves the liquid heated via the fins 54 away from the thermoelectric apparatus 38. As such, in certain embodiments, the heat removal apparatus 56 can include the fan and/or the fluid chamber and liquid.

Any suitable number of thermoelectric apparatuses 38 can be utilized, and the above describes one thermoelectric apparatus 38. Furthermore, any suitable number of films 48 can be utilized, and the above describes one film 48. For illustrative purposes, below discusses another configuration which utilizes more than one thermoelectric apparatus 38 and more than one film 48. As such, the desired number of thermoelectric apparatuses 38 and the desired number of films 48 can be utilized to provide the desired amount of cooling of the instrument panel 22.

The thermoelectric apparatus 38 can be a first thermoelectric apparatus 38A, and the film 48 can be a first film 48A. In this configuration, the first thermoelectric apparatus 38A can be coupled to the second surface 34 of the instrument panel 22, and the first film 48A can be secured to the second surface 34 of the instrument panel 22. Furthermore, the first film 48A can be thermally connected to the first conductive plate 42 of the first thermoelectric apparatus 38A. The first thermoelectric apparatus 38A and the first film 48A include the features discussed above, and will not be rediscussed.

Continuing with FIG. 3, the cooling assembly 12 can optionally include a second thermoelectric apparatus 38B that includes a first conductive plate 42 and a second conductive plate 44 spaced apart from each other. In certain embodiments, the first film 48A can be thermally connected to the first conductive plate 42 of the second thermoelectric apparatus 38B. Therefore, in certain embodiments, the first film 48A can be thermally connected to the first conductive plate 42 of the first and second thermoelectric apparatuses 38A, 38B. The second thermoelectric apparatus 38B can include the features discussed above, and the details will not be rediscussed.

The cooling assembly 12 can optionally include a second film 48B secured to the second surface 34 of the instrument panel 22. The second film 48B can be thermally connected to the first conductive plate 42 of the second thermoelectric apparatus 38B. The second film 48B can include the features discussed above, and the details will not be rediscussed.

The first conductive plate 42 of the first thermoelectric apparatus 38A and the first conductive plate 42 of the second thermoelectric apparatus 38B can both be configured to decrease in temperature during operation of the respective first and second thermoelectric apparatuses 38A, 38B. The second conductive plate 44 of the first thermoelectric apparatus 38A and the second conductive plate 44 of the second thermoelectric apparatus 38B can both be configured to increase in temperature during operation of the respective first and second thermoelectric apparatuses 38A, 38B. In certain embodiments, the first film 48A can decrease in temperature as at least the first conductive plate 42 of the first thermoelectric apparatus 38A decreases in temperature due to the thermal connection between the first film 48A and the first conductive plate 42 of the first thermoelectric apparatus 38A.

The first and second thermoelectric apparatuses 38A, 38B can be separate stand-alone units or operate together in a series connection. Said differently, in certain embodiments, the first thermoelectric apparatus 38A and the first film 48A can operate independently of the second thermoelectric apparatus 38B and the second film 48B. Alternatively, in certain embodiments, the first film 48A or the second film 48B is thermally connected to the first conductive plate 42 of both the first and second thermoelectric apparatuses 38A, 38B, such that the thermoelectric apparatuses 38A, 38B are in a series connection. Each of the thermoelectric apparatuses 38A, 38B can also include the heat exchanger 52, the heat removal apparatus 56, the fastening feature 50 which is discussed above and the details will not be rediscussed. It is to be appreciated that more than one film 48A, 48B can be thermally connected to the first and/or second thermoelectric apparatuses 38A, 38B.

While the best modes and other embodiments for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A cooling assembly comprising:
an instrument panel including a first surface and a second surface opposing the first surface;
a thermoelectric apparatus coupled to one of the first and second surfaces;
wherein the thermoelectric apparatus includes a first conductive plate and a second conductive plate spaced apart from each other, and wherein the first and second conductive plates are configured to be at different temperatures from each other during operation of the thermoelectric apparatus; and
a film secured to one of the first and second surfaces of the instrument panel and thermally connected to one of the first and second conductive plates of the thermoelectric apparatus such that operation of the thermoelectric apparatus causes the film to decrease in temperature by an amount sufficient for cooling the instrument panel.

2. The assembly as set forth in claim 1 wherein the first conductive plate is configured to decrease in temperature during operation of the thermoelectric apparatus and the second conductive plate is configured to increase in temperature during operation of the thermoelectric apparatus.

3. The assembly as set forth in claim 2 wherein the film is secured to the second surface of the instrument panel and the film is thermally connected to the first conductive plate.

4. The assembly as set forth in claim 3 wherein the film decreases in temperature as the first conductive plate decreases in temperature due to the thermal connection between the film and the first conductive plate.

5. The assembly as set forth in claim 3 further including a fastening feature attached to the film and the first conductive plate to thermally connect the film and the first conductive plate.

6. The assembly as set forth in claim 5 wherein the fastening feature is an adhesive formed of a thermally conductive material.

7. The assembly as set forth in claim 1 further including a heat exchanger coupled to one of the first and second conductive plates.

8. The assembly as set forth in claim 7 wherein the heat exchanger is coupled to the second conductive plate to remove heat from the thermoelectric apparatus.

9. The assembly as set forth in claim 8 wherein the heat exchanger includes a fan configured to move heated air away from the thermoelectric apparatus.

10. The assembly as set forth in claim 8 wherein the heat exchanger includes a plurality of fins secured to the second conductive plate and configured to absorb heat from the second conductive plate.

11. The assembly as set forth in claim 10 wherein the heat exchanger includes a fan disposed adjacent to the fins and configured to move air over the fins and expel the air heated via the fins away from the thermoelectric apparatus.

12. The assembly as set forth in claim 10 wherein the heat exchanger defines at least one fluid chamber configured to contain a liquid that absorbs heat from the fins and moves the liquid heated via the fins away from the thermoelectric apparatus.

13. The assembly as set forth in claim 1 wherein the film is formed of graphene.

14. The assembly as set forth in claim 13 wherein the graphene has a thermal conductivity of about 3000 to about 5000 Watts/meter-Kelvin at room temperature.

15. The assembly as set forth in claim 1 wherein the film is formed of a thermal conductive material of about 3000 to about 5000 Watts/meter-Kelvin at room temperature.

16. The assembly as set forth in claim 1 wherein the film is formed of a thermal conductive material of about 1200 to about 2000 Watts/meter-Kelvin at room temperature.

17. The assembly as set forth in claim 1:
wherein the thermoelectric apparatus is coupled to the second surface of the instrument panel;
wherein the first conductive plate is configured to decrease in temperature during operation of the thermoelectric apparatus and the second conductive plate is configured to increase in temperature during operation of the thermoelectric apparatus;
wherein the film is secured to the second surface of the instrument panel and at least partially abuts the second surface of the instrument panel;
wherein the film is thermally connected to the first conductive plate;
wherein the film decreases in temperature due to the thermal connection with the first conductive plate;
further including an adhesive formed of a thermally conductive material, and the adhesive thermally connects the film and the first conductive plate;
further including a heat exchanger coupled to the second conductive plate to remove heat from the second conductive plate;
wherein the heat exchanger includes a plurality of fins secured to the second conductive plate and configured to absorb heat from the second conductive plate; and
wherein the heat exchanger includes a heat removal apparatus configured to move heat from the fins away from the thermoelectric apparatus.

18. A passenger compartment for a vehicle; the passenger compartment comprising:
an instrument panel including an instrument cluster having a face;
wherein the instrument panel includes a first surface and a second surface opposing the first surface;
wherein at least a portion of the first surface of the instrument panel and the face of the instrument cluster are configured to be visible inside the passenger compartment;
a cooling assembly coupled to the instrument panel, the cooling assembly including:
a thermoelectric apparatus coupled to one of the first and second surfaces;
wherein the thermoelectric apparatus includes a first conductive plate and a second conductive plate spaced apart from each other, and wherein the first and second conductive plates are configured to be at different temperatures from each other during operation of the thermoelectric apparatus; and
a film secured to one of the first and second surfaces of the instrument panel and thermally connected to one of the first and second conductive plates of the thermoelectric apparatus such that operation of the thermoelectric apparatus causes the film to decrease in temperature by an amount sufficient for cooling the instrument panel.

19. The passenger compartment as set forth in claim 18:
wherein the thermoelectric apparatus is coupled to the second surface of the instrument panel;
wherein the first conductive plate is configured to decrease in temperature during operation of the thermoelectric apparatus and the second conductive plate is configured to increase in temperature during operation of the thermoelectric apparatus;
wherein the film is secured to the second surface of the instrument panel and at least partially abuts the second surface of the instrument panel;
wherein the film is thermally connected to the first conductive plate;
wherein the film decreases in temperature due to the thermal connection with the first conductive plate;
wherein the cooling assembly further includes an adhesive formed of a thermally conductive material, and the adhesive thermally connects the film and the first conductive plate;
wherein the cooling assembly further includes a heat exchanger coupled to the second conductive plate to remove heat from the second conductive plate;
wherein the heat exchanger includes a plurality of fins secured to the second conductive plate and configured to absorb heat from the second conductive plate; and
wherein the heat exchanger includes a heat removal apparatus configured to move heat from the fins away from the thermoelectric apparatus.

20. The passenger compartment as set forth in claim 18:
wherein the thermoelectric apparatus is a first thermoelectric apparatus and the film is a first film;
wherein the first thermoelectric apparatus is coupled to the second surface of the instrument panel;
wherein the first film is secured to the second surface of the instrument panel and the first film is thermally connected to the first conductive plate of the first thermoelectric apparatus;
wherein the cooling assembly further includes a second thermoelectric apparatus that includes a first conductive plate and a second conductive plate spaced apart from each other;
wherein the first film is thermally connected to the first conductive plate of the second thermoelectric apparatus;
wherein the cooling assembly further includes a second film secured to the second surface of the instrument panel and the second film is thermally connected to the first conductive plate of the second thermoelectric apparatus;
wherein the first conductive plate of the first thermoelectric apparatus and the first conductive plate of the second thermoelectric apparatus are both configured to decrease in temperature during operation of the respective first and second thermoelectric apparatuses;
wherein the second conductive plate of the first thermoelectric apparatus and the second conductive plate of the second thermoelectric apparatus are both configured to increase in temperature during operation of the respective first and second thermoelectric apparatuses; and
wherein the first film decreases in temperature as at least the first conductive plate of the first thermoelectric apparatus decreases in temperature due to the thermal connection between the first film and the first conductive plate of the first thermoelectric apparatus.
